(19) United States
(12) Patent Application Publication
(10) Pub. No.: US 2026/0044318 A1
(43) Pub. Date: Feb. 12, 2026

(54) CONTAINER IMAGE-BASED STORAGE AND DYNAMIC IMAGE LAYER REORDERING FOR MACHINE-LEARNED MODELS

(71) Applicant: Red Hat, Inc., Raleigh, NC (US)

(72) Inventor: Yuan Tang, Indianapolis, IN (US)

(21) Appl. No.: 18/980,978

(22) Filed: Dec. 13, 2024

Related U.S. Application Data
(60) Provisional application No. 63/680,364, filed on Aug. 7, 2024.

(51) Int. Cl. G06F 8/35; G06N 5/01

(52) U.S. Cl. CPC G06F 8/35; G06N 5/01

(57) ABSTRACT

A modification to a first model layer of a machine-learned model is identified based on a comparison between the machine-learned model and a prior version of the model. A first modification tracking variable of a plurality of modification tracking variables is updated, wherein each of the plurality of modification tracking variables tracks a number of modifications applied during prior training iterations to a corresponding model layer. A first container image is accessed, wherein a set of container image layers of the container stores the plurality of model layers ordered in a first sequence within the first container image. Based on the first modification tracking variable, a second container image is generated from the first container image that comprises the container image layers, wherein the container image layers are ordered in a second sequence within the second container image different than the first sequence.

### PRIORITY CLAIM

This application claims the benefit of, and priority based on, 35 U.S.C. § 119 to U.S. Provisional Application No. 63/680,364, filed August 7, 2024, which is incorporated herein by reference in its entirety.

### BACKGROUND

Containers are lightweight, standalone executable units that package application code along with dependencies, such as libraries, binaries, and configuration files, in a standardized format. Structurally, a container is built atop a container image, which includes the application and its runtime environment, and is isolated from the host system using operating system-level virtualization. This isolation is achieved through kernel features such as namespaces, which segregate resources like file systems, process trees, and network interfaces, and control groups (cgroups), which manage resource allocation and limits. Unlike traditional virtual machines, containers share the host operating system kernel, allowing them to operate independently while maintaining minimal overhead.

### SUMMARY

In one implementation a method is provided. The method includes identifying, by a computing system comprising one or more processor devices, a modification to a first model layer of a plurality of model layers of a machine-learned model based on a comparison between the machine-learned model and a prior version of the machine-learned model. The method further includes updating a first modification tracking variable of a plurality of modification tracking variables, wherein each of the plurality of modification tracking variables tracks a number of modifications applied during prior training iterations to a corresponding model layer of the plurality of model layers. The method further includes accessing a first container image comprising a plurality of container image layers, wherein a set of container image layers of the plurality of container image layers stores the plurality of model layers of the machine-learned model, and wherein the set of container image layers is ordered in a first sequence within the first container image. The method further includes based on the first modification tracking variable, generating a second container image from the first container image that comprises the plurality of container image layers, wherein the set of container image layers is ordered in a second sequence within the second container image, and wherein the second sequence is different than the first sequence.

In another implementation a computing system is provided. The computing system includes a memory and one or more processor devices coupled to the memory to identify a modification to a first model layer of a plurality of model layers of a machine-learned model based on a comparison between the machine-learned model and a prior version of the machine-learned model. The one or more processor devices are further to update a first modification tracking variable of a plurality of modification tracking variables, wherein each of the plurality of modification tracking variables tracks a number of modifications applied during prior training iterations to a corresponding model layer of the plurality of model layers. The one or more processor devices are further to access a first container image comprising a plurality of container image layers, wherein a set of container image layers of the plurality of container image layers stores the plurality of model layers of the machine-learned model, and wherein the set of container image layers is ordered in a first sequence within the first container image. The one or more processor devices are further to, based on the first modification tracking variable, generate a second container image from the first container image that comprises the plurality of container image layers, wherein the set of container image layers is ordered in a second sequence within the second container image, and wherein the second sequence is different than the first sequence.

In another implementation a non-transitory computer-readable storage medium is provided. The non-transitory computer-readable storage medium includes executable instructions to cause one or more processor devices to identify a modification to a first model layer of a plurality of model layers of a machine-learned model based on a comparison between the machine-learned model and a prior version of the machine-learned model. The instructions further cause the one or more processor devices to update a first modification tracking variable of a plurality of modification tracking variables, wherein each of the plurality of modification tracking variables tracks a number of modifications applied during prior training iterations to a corresponding model layer of the plurality of model layers. The instructions further cause the one or more processor devices to access a first container image comprising a plurality of container image layers, wherein a set of container image layers of the plurality of container image layers stores the plurality of model layers of the machine-learned model, and wherein the set of container image layers is ordered in a first sequence within the first container image. The instructions further cause the one or more processor devices to, based on the first modification tracking variable, generate a second container image from the first container image that comprises the plurality of container image layers, wherein the set of container image layers is ordered in a second sequence within the second container image, and wherein the second sequence is different than the first sequence.

Individuals will appreciate the scope of the disclosure and realize additional aspects thereof after reading the following detailed description of the examples in association with the accompanying drawing figures.

### BRIEF DESCRIPTION OF THE DRAWINGS

The accompanying drawing figures incorporated in and forming a part of this specification illustrate several aspects of the disclosure and, together with the description, serve to explain the principles of the disclosure.

FIG. 1 is a block diagram of a computing system for container image-based storage and dynamic image layer reordering for machine-learned models according to some implementations of the present disclosure.

FIG. 2 is a data flow diagram for containerizing a machine-learned model with the containerization module of FIG. 1 according to some implementations of the present disclosure.

FIG. 3 is a data flow diagram for reordering a container image storing a model that is restructured as a file structure directory according to some implementations of the present disclosure.

FIG. 4 is a flowchart illustrating operations performed by the computing system of FIG. 1 to implement container image-based storage and dynamic image layer reordering for machine-learned models, according to one example.

FIG. 5 is a block diagram of the computing system of FIG. 1 for container image-based storage and dynamic image layer reordering for machine-learned models, according to one example.

FIG. 6 is a block diagram of a computing system suitable for implementing examples according to one example.

### DETAILED DESCRIPTION

The examples set forth below represent the information to enable individuals to practice the examples and illustrate the best mode of practicing the examples. Upon reading the following description in light of the accompanying drawing figures, individuals will understand the concepts of the disclosure and will recognize applications of these concepts not particularly addressed herein. It should be understood that these concepts and applications fall within the scope of the disclosure and the accompanying claims.

Any flowcharts discussed herein are necessarily discussed in some sequence for purposes of illustration, but unless otherwise explicitly indicated, the examples and claims are not limited to any particular sequence or order of steps. The use herein of ordinals in conjunction with an element is solely for distinguishing what might otherwise be similar or identical labels, such as “first message” and “second message,” and does not imply an initial occurrence, a quantity, a priority, a type, an importance, or other attribute, unless otherwise stated herein. The term “about” used herein in conjunction with a numeric value means any value that is within a range of ten percent greater than or ten percent less than the numeric value. As used herein and in the claims, the articles “a” and “an” in reference to an element refers to “one or more” of the element unless otherwise explicitly specified. The word “or” as used herein and in the claims is inclusive unless contextually impossible. As an example, the recitation of A or B means A, or B, or both A and B. The word “data” may be used herein in the singular or plural depending on the context. The use of “and/or” between a phrase A and a phrase B, such as “A and/or B” means A alone, B alone, or A and B together.

The phrase “container” as used herein refers to a running process that is isolated from other processes via namespaces and cgroups. A container is executed (e.g., initiated or instantiated) from a container image. A container image is a static package of software comprising one or more layers, the layers including everything needed to run an application (i.e., as a container) that corresponds to the container image, including, for example, one or more of executable runtime code, system tools, system libraries and configuration settings. A Docker® image is an example of a container image. A container image typically includes one or more file directories that include all executables, other than the host operating system kernel, necessary for the container to run. The life-cycle of a container is managed by a container runtime, sometimes referred to as a container engine, such as, by way of non-limiting example, such as runC, crun, containerd, Docker, Windows Containers, and the like.

Containers are increasingly popular in cloud computing environments due, in part, to their lightweight footprint compared to a Virtual Machine (VM) and the speed at which a container can be initiated compared to a VM, while still maintaining strong isolation characteristics such that two containers executing in different namespaces on the same host are not inherently aware of one another and cannot negatively impact one another.

Containers are comprised of container image layers. Each image layer corresponds to a change or instruction in the container image, such as adding files, setting environment variables, or installing software. Image layers are ordered on top of one another in a sequence, starting from a base image, to collectively form a container image. Image layers are immutable, meaning once an image layer is created, it cannot be modified. Instead, changes to existing container images result in new image layers. The layer-based architecture of container images allows for efficient container storage and deployment because image layers can be reused across different images if the images share the same base / intermediate layers. If a change is made to a layer of a container image, a new container can be created without requiring changes to any layers “below” (i.e., preceding) the changed container image. However, layers that are “above” the changed layer generally must be reconstructed. As such, identifying which image layers are more likely to be changed and placing such layers at the “top” of the container image can substantially increase storage and deployment efficiency.

Recently, containers have been utilized to solve a variety of problems in the fields of Artificial Intelligence (AI) and Machine Learning (ML). For example, models can be stored to containers alongside necessary dependencies to enable model serving architectures in which models provide model-driven “services” (e.g., content generation services, predictive services, etc.). Because containers are efficiently instantiated and de-instantiated, storing models to containers can increase the efficiency of model serving architectures.

However, storing models to containers can also introduce a variety of inefficiencies. One such example is that containerization technologies often construct the image layers of the container based on existing file system structures. However, if the model changes frequently, re-uploading an updated model can require that the image layers are reconstructed from scratch. In other words, when a model is containerized and then receives additional training iterations, the container image storing the model must be reconstructed entirely. In turn, reconstructing the model can require substantial computing resources (e.g., power, memory, compute cycles, etc.). This problem is exacerbated for the storage of certain models which experience a high frequency of structural changes when subjected to additional training iterations. For example, decision tree models consist of multiple branches which can grow significantly as the model is fine-tuned (i.e., trained with additional training iterations, etc.). As such, a technique to reduce such inefficiencies is greatly desired.

Accordingly, implementations described herein propose container image-based storage and dynamic image layer reordering for machine-learned models. More specifically, a computing system can obtain a container image that stores a machine-learned model. The computing system can identify a modification to a model layer of the machine-learned model based on a comparison between the machine-learned model and a prior version of the machine-learned model. For example, the computing system may simply compare the container image storing the machine-learned model to a different container image storing the previous version of the model. For another example, the computing system may load the model and the previous version of the model from their respective container images to compare the models. Alternatively, the computing system may receive some information descriptive of the modification (e.g., from a model training system or the like).

The modification can refer to any change made to the model subsequent to the previous version. Examples of modifications can include adjustments to parameters of the model, hyperparameters of the model, the structure or architecture of the model (e.g., adding or deleting nodes from a decision tree), etc. The modification can result from a training iteration applied to the machine-learned model after the previous version of the model was created. For example, assume the model is a decision tree model with a node that evaluates whether a value is greater than a threshold value. In the previous version, the threshold value may be 10,000, while in the current version of the model, the threshold value may have been modified to be 11,000 in light of the additional training iteration(s).

The computing system can update a first modification tracking variable of a plurality of modification tracking variables. Each of the modification tracking variables can be associated with a corresponding model layer of the machine-learned model (and/or a container image layer that stores the corresponding model layer). The modification tracking variables can track a number or frequency of modifications made to the corresponding model layer over time. To follow the previous example, the node of the decision tree model that evaluates whether the value is greater than the threshold value can be a model layer, and the modification tracking variable associated with that node (e.g., the first modification tracking variable) can be incremented in response to identifying the modification to the model layer.

The computing system can access a first container image with a plurality of container image layers. A set of container image layers of the plurality of container image layers can store the plurality of model layers of the machine-learned model. More specifically, each container image layer can store one (or more) model layers of the machine-learned model. The set of container image layers that collectively store the machine-learned model can be ordered in a first sequence within the first container image.

Based on the first modification tracking variable, the computing system can generate a second container image from the first container image that comprises the plurality of container image layers. The set of container image layers can be ordered in a second sequence within the second container image that is different than the first sequence. For example, assume that the first modification tracking variable has a value of 15 before the variable was updated and a second modification tracking variable associated with a second model layer also has a value of 15. Further assume that, in the first sequence, the container image layer storing the second model layer is located “below” the container image layer storing the first model layer (i.e., is located closer to the base image layer).

Once incremented the first modification tracking variable can be greater than the second modification tracking variable. In response, the computing system can generate the second container image such that the second sequence places the container image layer storing the second model layer “above” the container image layer storing the first model layer. In this manner, the image layers that change most frequently can be relocated to the “top” of the container image, while the image layers least likely to change can serve as the “base” and “intermediate” image layers of the container image. Base image layers refer to the “first” image layer of the container, and may also be referred to as a foundational image layer.

By dynamically reordering the layers of the first container image to generate the second container image, implementations described herein can substantially increase storage and deployment efficiency for containers storing machine-learned models. Specifically, as described above, image layers located “above” an image layer that has been changed are reconstructed when a new container image is generated, and reconstruction of such layers generally requires the expenditure of computing resources (e.g., power, memory, compute cycles, bandwidth, etc.). As such, by placing layers most likely to be changed at the ”top” of the container, implementations described herein substantially reduce the expenditure of computing resources associated with reconstructing image layers for containers.

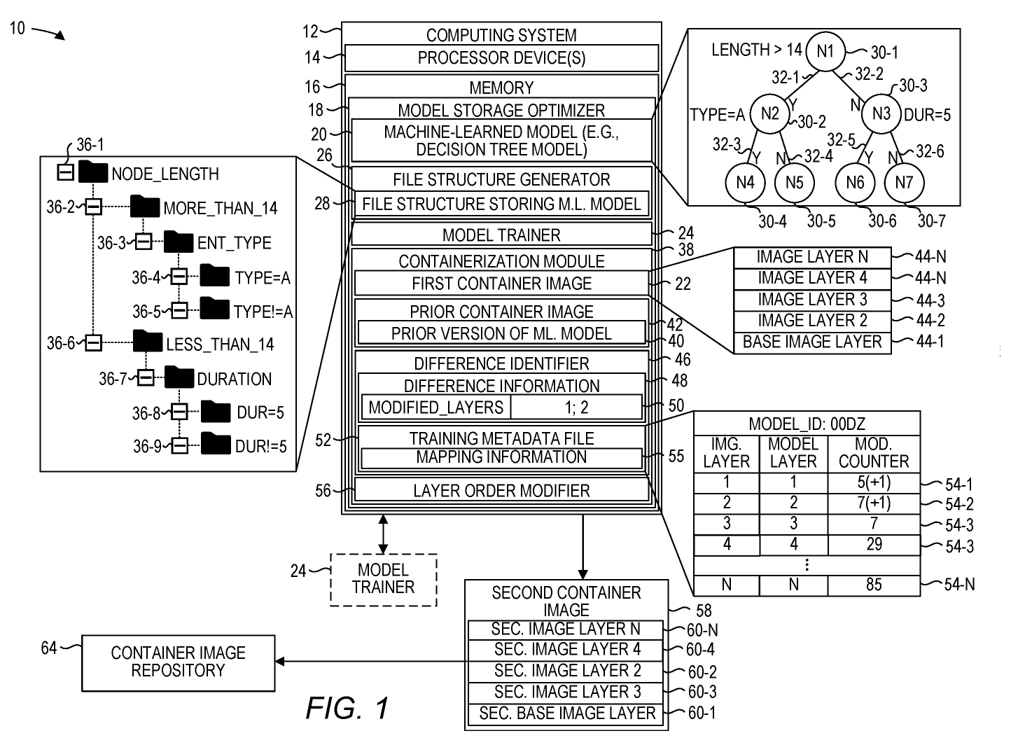

FIG. 1 is a block diagram of a computing system for container image-based storage and dynamic image layer reordering for machine-learned models according to some implementations of the present disclosure. FIG. 1 depicts an execution environment 10 that includes a computing system 12. The computing system 12 includes processor device(s) 14 and a memory 16. The computing system 12 can be any type or manner of computing device or network node, and can include physical computing device(s) (e.g., Central Processing Units (CPUs), Graphics Processing Units (GPUs), memory, accelerators, virtualized device(s) or service(s), etc. For example, the computing system 12 can be a virtualized node within a cloud-based computing environment that has indirect access to computing resources through a virtualization layer.

The processor device(s) 14 of the computing system 12 may include any computing or electronic device capable of executing software instructions to implement the functionality described herein. The memory 16 of the computing system 12 can be or otherwise include any device(s) capable of storing data, including, but not limited to, volatile memory (random access memory, etc.), non-volatile memory, storage device(s) (e.g., hard drive(s), solid state drive(s), etc.). In some implementations, the memory 16 can include a containerized unit of software instructions (i.e., a “packaged container”). The containerized unit of software instructions can collectively form a container that has been packaged using any type or manner of containerization technique.

The containerized unit of software instructions can include one or more applications, and can further implement any software or hardware necessary for execution of the containerized unit of software instructions within any type or manner of computing environment. For example, the containerized unit of software instructions can include software instructions that contain or otherwise implement all components necessary for process isolation in any environment (e.g., the application, dependencies, configuration files, libraries, relevant binaries, etc.).

The execution environment 10 can refer to a logical grouping, or clustering, of computing systems, devices, and/or resources. More specifically, the execution environment 10 is an environment in which a number of separate devices and/or systems share resources (e.g., hardware resources, compute cycles, services, etc.) via a central management framework that enforces consistent configuration and policies. It should be noted that the execution environment 10 can include any type or manner of computing device or system. For example, in some implementations, the execution environment 10 can include a number of computing systems and classical computing systems.

The memory 16 of the computing system 12 can include a model storage optimizer 18. The model storage optimizer 18 can handle containerization of machine-learned models for efficient model storage and deployment (e.g., creating new models, modifying existing models, storing existing models, creating new container images based on model updates, etc.). To do so, the model storage optimizer 18 can obtain a machine-learned model 20. In some implementations, the model storage optimizer 18 can obtain the machine-learned model 20 by loading the machine-learned model 20 from a first container image 22. For example, if the machine-learned model 20 is stored to the first container image 22, the computing system 12 can obtain the machine-learned model 20 by executing the first container image 22 to load the machine-learned model 20 to the memory 16. Alternatively, in some implementations, the model storage optimizer 18 can obtain the machine-learned model 20 from a model trainer 24. The model trainer 24 can be an external system within the computing environment 10, or can be a component of the computing system 12. The model trainer 24 can train the machine-learned model 20 and then provide the machine-learned model 20 to the model storage optimizer 18 for containerization and storage.

The machine-learned model 20 can be or otherwise include any type of model, such as neural networks (e.g., deep neural networks) or other types of machine-learned models, including non-linear models and/or linear models. Neural networks can include feed-forward neural networks, recurrent neural networks (e.g., long short-term memory recurrent neural networks), convolutional neural networks or other forms of neural networks. Some example machine-learned models can leverage an attention mechanism such as self-attention. For example, some example machine-learned models can include multi-headed self-attention models (e.g., transformer models, etc.).

In some implementations, the model storage optimizer 18 can include a file structure generator 26. The file structure generator 26 can generate a file structure storing the machine-learned model 20. More specifically, the file structure generator 26 can “restructure” the machine-learned model 20 as a file “directory” or structure to obtain a file structure 28 that stores the machine-learned model 20. For example, assume the machine-learned model is a feed-forward network with multiple layers including a “starting” input layer and a “final” output layer. Each layer of the model can be stored as a separate branch of a file directory. For example, each layer of the model may include a file corresponding to a subsequent layer to collectively form a sequence of nested file branches (e.g., a first file representing the input layer can include a file path representing the second layer, the file path representing the second layer can include a file path representing the third layer, etc.).

To follow the depicted example, the machine-learned model 20 can be a decision tree model that includes a plurality of model layers 30-1 – 30-3 (generally, model layers 30). As depicted, if the machine-learned model 20 is a decision tree model, the model layers 30 may be referred to interchangeably as nodes 30. Each of the model layers 30 (or “nodes”) can represent a decision in which a condition is evaluated, and based on the evaluation of the condition, a subsequent decision can be selected. For example, the ”base” node 30-1 (i.e., root node) represents a decision in which an input length is evaluated for an input to the model. If the length of the input is greater than 14, the model navigates to node 30-2, while if the node is less than or equal to 14, the model navigates to node 30-3. At nodes 30-2 and 30-3, subsequent decisions are made based on conditions that are evaluated (e.g., whether the input is a type “A” at node 30-2, whether a duration associated with the input is equal to five at node 30-3, etc.).

The machine-learned model (i.e., decision tree model) 20 can terminate at model layers 30-4 – 30-7. The model layers 30-4 – 30-7 are the terminal model layers or nodes of the model (i.e., “leaves”), and can represent outcomes or “final” decisions of the model. For example, the model layer 30-4 and 30-5 may be different output values for the decision tree model. In some implementations, when referring to a decision tree model, a model “layer” may refer to a single node of the decision tree model.

The machine-learned model (i.e., decision tree model) 20 can also include branches 32-1 – 32-N (generally, branches 32). The branches 32 can represent specific outcomes of the decision tree that lead to subsequent nodes of the decision tree. Generally, each model layer 30 (or “node) of the decision tree (other than terminal nodes or “leaves”) can include two branches representing either outcome of the condition being evaluated. For example, the model layer 30-1 includes a “yes” branch 32-1 that is traversed if the input length is evaluated to be greater than 14, and a “no” branch 32-2 that is traversed if the input length is evaluated to be less than or equal to 14. The branches 32 can be stored as discrete file paths within a file structure, which will be discussed subsequently.

The decision tree model (e.g., the machine-learned model 20) can be restructured as the file structure 28. The file structure 28 can include a plurality of file paths 36-1 – 36-9 (generally, file paths 36). Each of the file paths 36 can represent a corresponding model layer 30 and/or branch 32 of the machine-learned model 20. In addition, the file paths 36 can be structured within the file structure 28 to mirror the hierarchical organization of the model layers 30 and the branches 32 of the machine-learned model 20. For example, as the model layers 30-2 and 30-3 depend from the “base” model layer 30-1, the file paths 36-2 and 36-6 can depend from base file path 36-1. For another example, as the branches 32-3 and 32-4 depend from, or are “connected to” the model layer 30-2, the file paths 36-4 and 36-5 can depend from the file path 36-3.

The model storage optimizer 18 can include a containerization module 38. The containerization module 38 can create container images to store machine-learned models. More specifically, the containerization module 38 can create new container images to store different versions of the machine-learned model 20 as new versions are created by the model trainer 24 applying additional training variations to the machine-learned model 20.

For example, assume that, prior to obtaining the machine-learned model 20, the model storage optimizer 18 obtains a prior version 40 of the machine-learned model 20. The model storage optimizer 18 can utilize the containerization module 38 to create a prior container image 42 that stores the prior version 40 of the machine-learned model 20. Further assume that the model storage optimizer subsequently receives the machine-learned model 20 (i.e., the “current” version of the model) following the performance of additional training iterations to the prior version 40 of the machine-learned model 20 using the model trainer 24. The model storage optimizer 18 can then use the containerization module 38 to generate the first container image 22 to store the “current” version of the machine-learned model 20.

The containerization module 38 can create new container images when the machine-learned model 20 is updated because container images are immutable, and as such, the containerization module 38 cannot simply modify an existing container image to add changes to the model. Further, due to the “feed-forward” structure of most machine-learned models, layers that are located downstream of modified layers are “dependent” on the changed layers and therefore must be recreated. As such, by placing image layers most likely to change at the “top” of the container image, implementations described herein can minimize the substantial computational cost associated with recreating container image layers.

To follow the depicted example, assume that the model layer 30-3 in the prior version 40 of the machine-learned model 20 evaluates whether the “DURATION=3”. Further assume that the model trainer 24 performs additional training iterations to the prior version 40 of the machine-learned model 20 which modify the model layer 30-3 (i.e., node) to evaluate whether the “DURATION=5.” Once the model layer 30-3 is modified, the container image layer of the prior container image 42 that stores the model layer 30-3 must be recreated, along with any image layers located “above” that image layer. When creating the first container image 22, the containerization module 38 can utilize any unmodified layers that are not dependent on modified layers as-is (e.g., are located “below” any modified layers). For example, if the node 30-1 (e.g., the “base” node) is unchanged between the machine-learned model 20 and the prior version 40, the containerization module 38 can retrieve unmodified layers from cache to build the first container or can “link” to the unmodified layers in a container image repository.

Specifically, the first container image 22 can include a plurality of container image layers 44-1 – 44-N (generally, image layers 44). To create the first container image 22, the containerization module 38 can store each model layer of the machine-learned model 20 in a corresponding image layer 44 of the first container image 22. In some implementations, if the machine-learned model is re-structured or “stored” as the file structure 28, each of the image layers 44 can store a corresponding file path of the file paths 36.

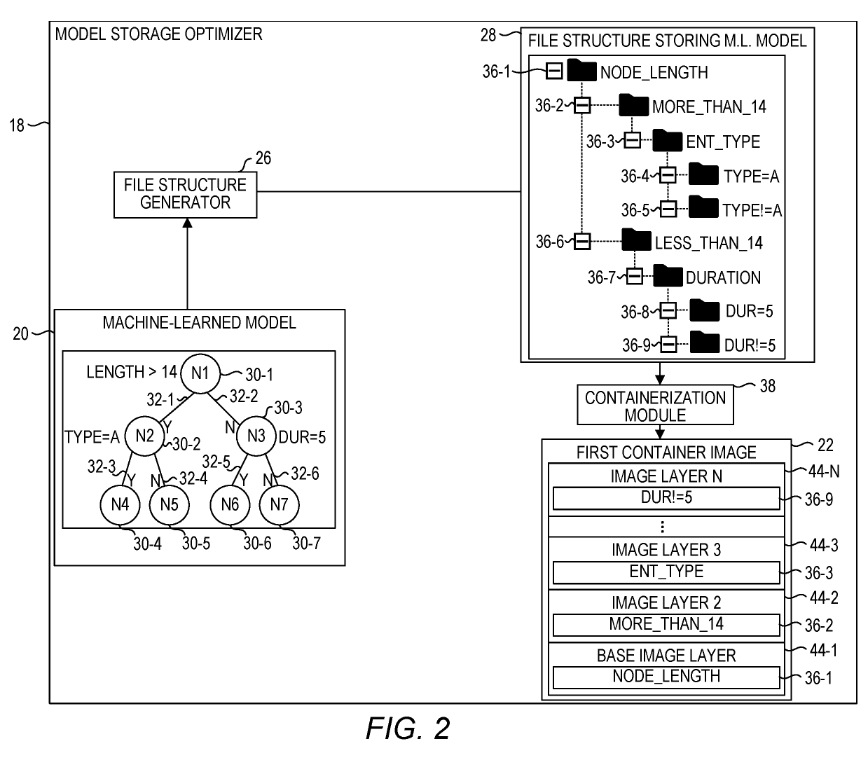

For a more specific example, turning to FIG. 2, FIG. 2 is a data flow diagram for containerizing a machine-learned model with the containerization module of FIG. 1 according to some implementations of the present disclosure. FIG. 2 will be discussed in conjunction with FIG. 1. More specifically, as depicted, the machine-learned model 20 can be a decision tree model that includes a plurality of model layers 30 and branches 32. The machine-learned model can be processed using the file structure generator 26 of the model storage optimizer 18 to “restructure”, convert, or otherwise store the machine-learned model as a file structure 28.

The file paths 36 of the file structure can store the model layers 30 and branches 32 of the machine-learned model 20 while retaining any hierarchical organization present in the machine-learned model 20. For example, model layers (i.e., nodes) 30-2 and 30-3 both depend from model layer 30-1. File paths 36-3 and 36-7 can (at least partially) represent model layers 30-2 and 30-3, respectively, and file path 36-1 can represent model layer 30-1. As depicted, the file paths 36-3 and 36-7 are nested within the file path 36-1, thus mirroring (and retaining) the hierarchical organization present in the machine-learned model 20.

It should be noted that, in some instances, more than one file path may be used to represent a single “node” or model layer of the machine-learned model 20. For example, model layer 30-1 of the machine-learned model represents a “decision” node in which a length of an input is evaluated. Based on the outcome of the evaluation (e.g., the decision value), the model navigates to either model layer 30-2 or model layer 30-3. The file structure 28 can include file paths 36-1 (e.g., “NODE_LENGTH”), 36-2 (e.g., “MORE_THAN_14”), and 36-6 (e.g., “LESS_THAN_14”) to collectively store the model layer 30-1 and the branches originating from the model layer 30-1 towards the model layers 30-2 and 30-3. In other words, to represent a node in a decision tree, the file structure 28 can include file paths to represent the node itself and the decision branches representing outcomes of the evaluated condition.

The containerization module 38 can process the file structure 28 storing the machine-learned model 20 to generate the first container image 22. The first container image 22 can include the plurality of image layers 44. Some (or all) of the image layers 44 can store corresponding file paths of the file structure 28. For example, the base image layer 44-1 can store the file path 36-1, the image layer 44-2 can store the file path 36-2, etc. It should be noted that FIG. 2 is included primarily to illustrate example implementations for containerization of machine-learned models and decision tree models in particular. The ordering (and/or reordering) of container image layers based on their corresponding model layers will be discussed subsequently.

Returning to FIG. 1, the image layers 44 can store the file paths 36 of the file structure 28 if the machine-learned model 20 has been restructured as the file structure 28. If the machine-learned model 20 has not been restructured, the image layers 44 can store the model layers 30 and branches 32 of the machine-learned model 20 directly. For example, assume that the image layer 44-3 stores the model layer 30-3. The image layer 44-3 can include information descriptive of the structure of the model layer 30-3, weights associated with parameters of the model layer 30-3, training metadata for that particular layer, etc.

The containerization module 38 can include a difference identifier 46. The difference identifier 46 can identify any modifications made to specific model layers as a result of the training iterations performed by the model trainer 24 to the prior version 40 of the machine-learned model 20. Specifically, the difference identifier can compare the machine-learned model 20 and the previous version 40 of the machine-learned model 20 (and/or the first container image 22 and the prior container image 42) to generate difference information 48. The difference information 48 can identify modified layer(s) and the modifications 50 made to those the modified layer(s).

To do so, in some implementations, the difference identifier 46 can identify the modifications made to the machine-learned model 20 by comparing the model itself to the previous version 40 of the model. Modifications can include changes to parameters, weights, the addition of a new model layer, the removal of an existing model layer, the splitting of an existing model layer, etc. For example, the difference identifier 46 can compare the weights, parameters, structure, etc. of specific layers of the model to corresponding layers of the previous version. In some implementations, the comparison can be made by loading the models from the first container image 22 and the prior container image 42 and comparing the models directly.

Alternatively, in some implementations, the difference identifier 46 can identify the modifications made to the machine-learned model 20 by comparing the first container image 22, which stores the machine-learned model 20, to the prior container image 42, which stores the prior version 40. For example, if the machine-learned model 20 is restructured as the file structure 28 for storage in the first container image 22, the difference identifier 46 can compare the name of each image layer to identify differences between the models.

The difference identifier 46 can include a training metadata file 52. The training metadata file 52 can include a plurality of modification tracking variables 54-1 – 54-N (generally, modification tracking variables 54). In some implementations, each of the modification tracking variables can track a quantity of modifications made to a corresponding model layer of the plurality of model layers 30 (i.e., nodes) and branches 32. The difference identifier 46 can update modification tracking variables based on the difference information 48. For example, the difference information 48 indicates that model layer 30-1 has been modified subsequent to creation of the prior version 40 of the machine-learned model 20. In response, the difference identifier 46 can increment the modification tracking variable 54-1 which tracks modifications made to the model layer 30-1. Alternatively, in some implementations, if more than one model layer is stored to a corresponding image layer of the container image, the modification tracking variables can track a quantity of modifications made to model layers stored to the particular image layer.

In some implementations, the training metadata file 52 can also store mapping information 55. The mapping information 55 can map the model layers 30 and branches 32 to corresponding file paths 36. The mapping information 55 can further map the file paths 36 to the corresponding image layers 44. In this manner, as the image layers are reordered, the model layers and file paths corresponding to the image layer can be identified.

The containerization module 38 can include a layer order modifier 56. The layer order modifier 56 can reorder the order of the image layers 44 of the first container image 22 based on the updated modification tracking variables 54. Specifically, the layer order modifier 56 can reorder the image layers 44 based on their associated modification tracking variables so that the image layer with the highest associated modification tracking variable is placed at the “top” of the container image while the image layer with the lowest associated modification tracking variable is placed at the “bottom” of the container image.

By reordering the image layers 44 of the first container image 22, the containerization module 38 can generate a second container image 58. The second container image 58 can include second image layers 60-1 – 60-N (generally, second image layers 60). The second image layers 60 can include the same image layers as those of the image layers 44. However, the second image layers 60 can be ordered in a different sequence than the ordered sequence of the image layers 44 of first container image 22. For example, the image layers 44 can be ordered based on their corresponding modification tracking variables 54.

To follow the depicted example, the difference information 48 can indicate that the modification(s) 50 include a modification to the model layer 30-2 (e.g., model layer 2). Prior to the difference information 48 being generated, the modification tracking variable 54-2 that tracks modifications to the model layer 30-2 can be equal to the modification tracking variable 54-3 that tracks modifications to the model layer 30-3. Once the difference information 48 is generated, the difference identifier 46 can increment the modification tracking variable 54-2 so that the modification tracking variable 54-2 is greater than the modification tracking variable 54-3. In response, the layer order modifier 56 can modify the order of the image layers 44 to generate the second container image 58. The second image layers 60 can be reordered such that the second image layer 60-2 storing the model layer 30-2 can be ordered “above” the third image layer 60-3 storing the model layer 30-3.

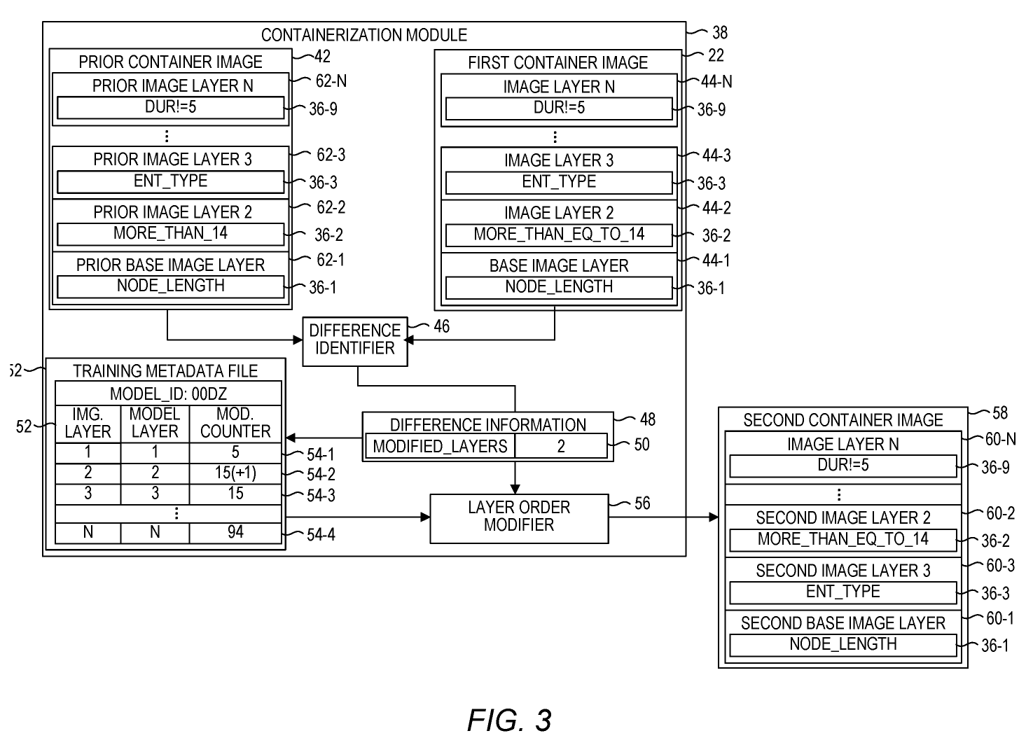

For a more specific example, turning to FIG. 3, FIG. 3 is a data flow diagram for reordering a container image storing a model that is restructured as a file structure directory according to some implementations of the present disclosure. More specifically, the containerization module 38 can obtain the prior container image 22. The prior container image 42 can include prior image layers 62-1 – 62-N (generally, prior image layers 62). The prior image layers 62 can store the model layers 30 and branches 32 of the machine-learned model 20. More specifically, the prior version 40 of the machine-learned model 20 can be restructured as a file structure and the file paths of the file structure can be stored to the prior image layers 62 analogously as described with regards to the file structure 28 and the first container image 22.

The prior image layer 62-2 can store the file path 36-2. The corresponding image layer 44-2 of the first container image 22 can also store the file path 36-2. However, the file path 36-2 as stored to the prior image layer 62-2 can be different in comparison to the file path 36-2 as stored to the image layer 44-2. This can be due to additional training iterations that modify the file path 36-2 (and/or the corresponding model layer 30-1). As depicted, the file path 36-2 can specify a condition in which the “length” is more than 14 in the prior image layer 62-2, while in the image layer 44-2, the file path 36-2 can specify to evaluate whether the “length” is more than or equal to 14.

The difference identifier 46 can evaluate the prior container image 42 and the first container image 22 to generate the difference information 48. The difference information 48 can identify the file path 36-2 (or the model layer(s) to which the file path 36-2 corresponds) as a modified file path. The difference identifier 46 can then increment the modification tracking variable 54-2 that tracks modifications to the file path 36-2 (or the corresponding model layer(s)).

The layer order modifier 56 can evaluate the modification tracking variables 54 to determine whether the image layers 44 should be reordered. Once the value of the modification tracking variable 54-2 is incremented to 16, it becomes higher than the modification tracking variable 54-3 associated with the file path 36-3. The mapping information 55 of the training metadata file 52 can map the modification tracking variable 54-2 to the file path 36-2 and the image layer 44-2. The mapping information 55 of the training metadata file 52 can further map the modification tracking variable 54-3 to the file path 36-3 and the image layer 44-3.

The layer order modifier 56 can reorder the image layers 44 of the first container image 22 based on the newly updated modification tracking variable 54-2 being higher than the modification tracking variable 54-2. By doing so, the layer order modifier 56 can generate the second container image 58. The second container image 58 can include the second image layers 60, which in turn can store the file paths 36 as described with regards to the prior container image 42 and the first container image 22.

Like the image layers 44, which are ordered in a first sequence, the second image layers 60 of the second container image 58 are ordered in a second sequence different than the first sequence. As depicted, the second sequence differs from the first sequence in that the layer order determinator 55 has swapped locations of the second image layer 60-2 and the second image layer 60-3 based on the modification tracking variables 54. More specifically, because the file path 36-2 stored by the second image layer 60-2 has been updated more frequently than the file path 36-3 stored by the second image layer 60-3, the layer order modifier 56 modifies the order of the second image layers 60 so that the second image layer 60-2 is located above the second image layer 60-3. As a result, each time the file path 36-2 is updated, the second image layer 60-3 will no longer need to be reconstructed, as it is now located “below” the second image layer 60-2 which holds the file path 36-2 and is therefore no longer dependent on the second image layer 60-2. In such fashion, implementations described herein can reduce the computational complexity associated with model storage and containerization.

Returning to FIG. 1, the layer order modifier 56 can generate the second container image 58 based on the modification tracking variables 54 as described with regards to FIG. 3. In some implementations, the layer order modifier 56 can generate the second container image 58 by constructing a new container that branches from the unmodified image layers of the first container image 22. If the first container image 22 is sufficiently optimized (e.g., has been processed with the model storage optimizer 18 over a number of iterations), the process of constructing a new container can be relatively inexpensive, as any modified layer(s) are likely to be located at the “top” of the container image to minimize the number of image layers that need to be reconstructed. Alternatively, in some implementations, the layer order modifier 56 can generate the second container image 58 by modifying the first container image 22 to reorder the image layers 44 within the container image 22.

In some implementations, the second container image 58 can be transmitted to and stored in a container image repository 64. The container image repository 64 can store various container images that have been optimized using the model storage optimizer 18.

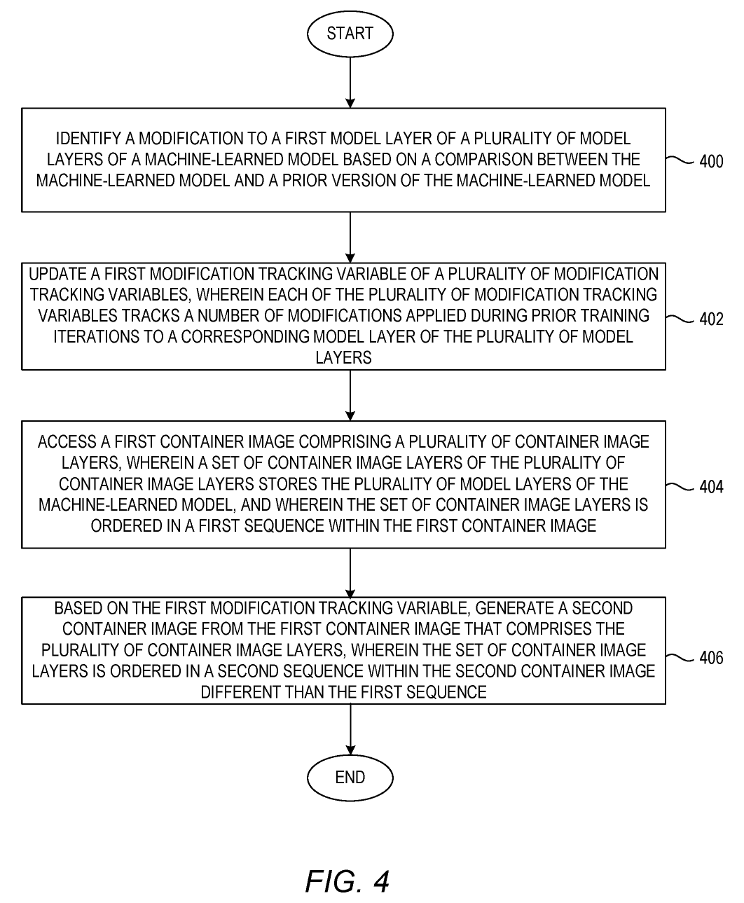

FIG. 4 is a flowchart illustrating operations performed by the computing system of FIG. 1 to implement container image-based storage and dynamic image layer reordering for machine-learned models, according to one example. Elements of FIG. 1 are referenced in describing FIG. 4 for the sake of clarity. In FIG. 4, operations begin with a processor device of a computing device, computing system, network node, etc., such as the processor device(s) 14 of the computing system 12 of FIG. 1. The processor device(s) 14 are to identify a modification 50 to a first model layer 30-1 of a plurality of model layers 30 of a machine-learned model 20 based on a comparison between the machine-learned model 20 and a prior version 40 of the machine-learned model 20 (block 400). The processor device(s) 14 are further to update a first modification tracking variable 54-1 of a plurality of modification tracking variables 54, wherein each of the plurality of modification tracking variables 54 tracks a number of modifications applied during prior training iterations to a corresponding model layer of the plurality of model layers 30 (block 402). The processor device(s) 14 are further to access a first container image 22 comprising a plurality of container image layers 44, wherein a set of container image layers of the plurality of container image layers 44 stores the plurality of model layers 30 of the machine-learned model, and wherein the set of container image layers is ordered in a first sequence within the first container image 22 (block 404). The processor device(s) 14 are further to, based on the first modification tracking variable 54-1, generate a second container image 58 from the first container image 22 that comprises the plurality of container image layers 44, wherein the set of container image layers is ordered in a second sequence within the second container image 58 different than the first sequence (block 406).

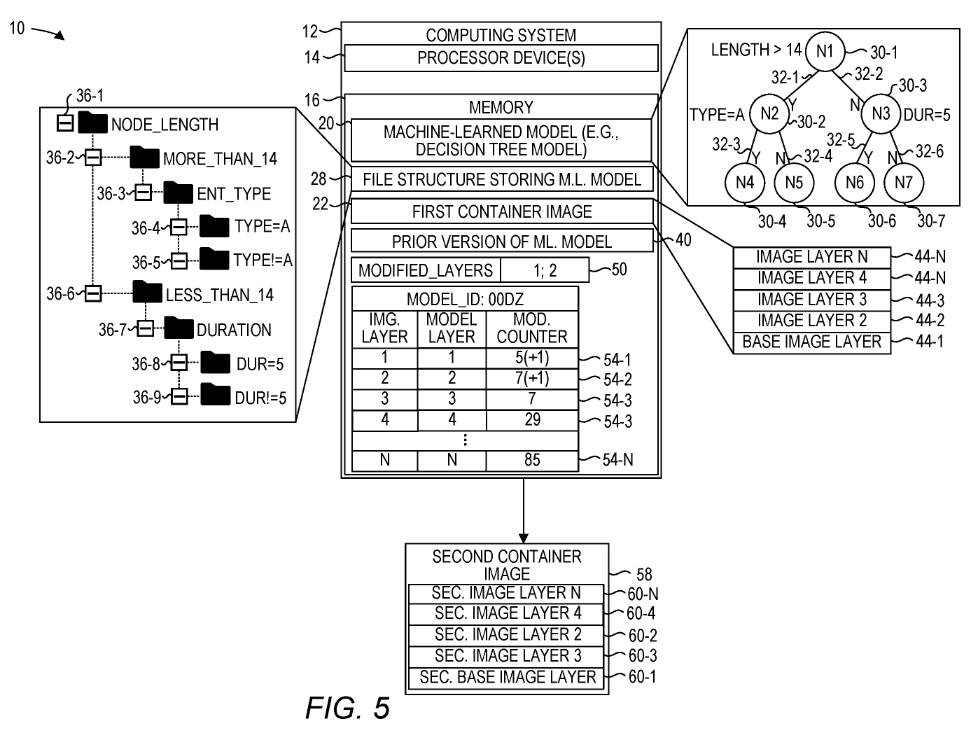

FIG. 5 is a block diagram of the computing system of FIG. 1 for container image-based storage and dynamic image layer reordering for machine-learned models, according to one example. Elements of FIG. 1 are referenced in describing FIG. 5 for the sake of clarity. In the example of FIG. 5, the computing system 12 includes a memory 16 and processor device(s) 14 coupled to the memory 16. The processor device(s) 14 are to identify a modification 50 to a first model layer 30-1 of a plurality of model layers 30 of a machine-learned model 20 based on a comparison between the machine-learned model 20 and a prior version 40 of the machine-learned model 20. The processor device(s) 14 are further to update a first modification tracking variable 54-1 of a plurality of modification tracking variables 54, wherein each of the plurality of modification tracking variables 54 tracks a number of modifications applied during prior training iterations to a corresponding model layer of the plurality of model layers 30. The processor device(s) 14 are further to access a first container image 22 comprising a plurality of container image layers 44, wherein a set of container image layers of the plurality of container image layers 44 stores the plurality of model layers 30 of the machine-learned model, and wherein the set of container image layers is ordered in a first sequence within the first container image 22. The processor device(s) 14 are further to, based on the first modification tracking variable 54-1, generate a second container image 58 from the first container image 22 that comprises the plurality of container image layers 44, wherein the set of container image layers is ordered in a second sequence within the second container image 58 different than the first sequence.

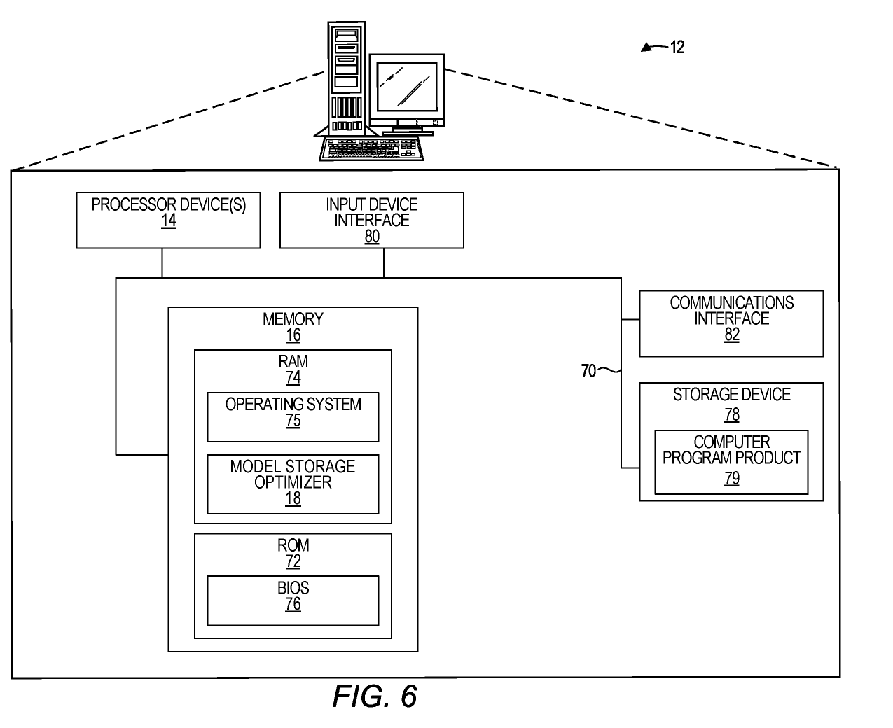

FIG. 6 is a block diagram of the computing system 12 suitable for implementing examples according to one example. The computing system 12 may comprise any computing or electronic device capable of including firmware, hardware, and/or executing software instructions to implement the functionality described herein, such as a computer server, a desktop computing device, a laptop computing device, a smartphone, a computing tablet, or the like. The computing system 12 includes the processor device(s) 14, the memory 16, and a system bus 70. The system bus 70 provides an interface for system components including, but not limited to, the memory 16 and the processor device(s) 14. The processor device(s) 14 can be any commercially available or proprietary processor.

The system bus 70 may be any of several types of bus structures that may further interconnect to a memory bus (with or without a memory controller), a peripheral bus, and/or a local bus using any of a variety of commercially available bus architectures. The memory 16 may include non-volatile memory 72 (e.g., read-only memory (ROM), erasable programmable read-only memory (EPROM), electrically erasable programmable read-only memory (EEPROM), etc.), and volatile memory 74 (e.g., random-access memory (RAM)). A basic input/output system (BIOS) 76 may be stored in the non-volatile memory 72 and can include the basic routines that help to transfer information between elements within the computing system 12. The volatile memory 74 may also include a high-speed RAM, such as static RAM, for caching data.

The computing system 12 may further include or be coupled to a non-transitory computer-readable storage medium such as the storage device 78, which may comprise, for example, an internal or external hard disk drive (HDD) (e.g., enhanced integrated drive electronics (EIDE) or serial advanced technology attachment (SATA)), HDD (e.g., EIDE or SATA) for storage, flash memory, or the like. The storage device 78 and other drives associated with computer-readable media and computer-usable media may provide non-volatile storage of data, data structures, computer-executable instructions, and the like.

A number of modules can be stored in the storage device 78 and in the volatile memory 74, including an operating system 75 and one or more program modules, such as the model storage optimizer 18, which may implement the functionality described herein in whole or in part. All or a portion of the examples may be implemented as a computer program product 79 stored on a transitory or non-transitory computer-usable or computer-readable storage medium, such as the storage device 78, which includes complex programming instructions, such as complex computer-readable program code, to cause the processor device(s) 14 to carry out the steps described herein. Thus, the computer-readable program code can comprise software instructions for implementing the functionality of the examples described herein when executed on the processor device(s) 14. The processor device(s) 14, in conjunction with the model storage optimizer 18 in the volatile memory 74, may serve as a controller, or control system, for the computing system 12 that is to implement the functionality described herein.

Because the model storage optimizer 18 is a component of the computing system 12, functionality implemented by the model storage optimizer 18 may be attributed to the computing system 12 generally. Moreover, in examples where the model storage optimizer 18 comprises software instructions that program the processor device(s) 14 to carry out functionality discussed herein, functionality implemented by the model storage optimizer 18 may be attributed herein to the processor device(s) 14.

An operator, such as a user, may also be able to enter one or more configuration commands through a keyboard (not illustrated), a pointing device such as a mouse (not illustrated), or a touch-sensitive surface such as a display device. Such input devices may be connected to the processor device(s) 14 through an input device interface 80 that is coupled to the system bus 70 but can be connected by other interfaces such as a parallel port, an Institute of Electrical and Electronic Engineers (IEEE) 1394 serial port, a Universal Serial Bus (USB) port, an IR interface, and the like. The computing system 12 may also include a communications interface 82 suitable for communicating with a network as appropriate or desired. The computing system 12 may also include a video port configured to interface with the display device, to provide information to the user.

Individuals will recognize improvements and modifications to the preferred examples of the disclosure. All such improvements and modifications are considered within the scope of the concepts disclosed herein and the claims that follow.

What is claimed is:

1. A method, comprising:
identifying, by a computing system comprising one or more processor devices, a modification to a first model layer of a plurality of model layers of a machine-learned model based on a comparison between the machine-learned model and a prior version of the machine-learned model;
updating a first modification tracking variable of a plurality of modification tracking variables, wherein each of the plurality of modification tracking variables tracks a number of modifications applied during prior training iterations to a corresponding model layer of the plurality of model layers;
accessing a first container image comprising a plurality of container image layers, wherein a set of container image layers of the plurality of container image layers stores the plurality of model layers of the machine-learned model, and wherein the set of container image layers is ordered in a first sequence within the first container image; and
based on the first modification tracking variable, generating a second container image from the first container image that comprises the plurality of container image layers, wherein the set of container image layers is ordered in a second sequence within the second container image, and wherein the second sequence is different than the first sequence.

2. The method of claim 1, wherein identifying the modification to the model layer of the plurality of model layers of the machine-learned model based on the comparison between the machine-learned model and the prior version of the machine-learned model comprises:
loading the machine-learned model from the first container image;
loading the prior version of the machine-learned model from a container image that stores the prior version of the machine-learned model; and
comparing the machine-learned model and the prior version of the machine-learned model to identify the modification to the first model layer of the plurality of model layers of the machine-learned model.

3. The method of claim 1, wherein identifying the modification to the first model layer of the plurality of model layers of the machine-learned model based on the comparison between the machine-learned model and the prior version of the machine-learned model comprises:
comparing information indicative of the first container image and information indicative of a container image that stores the prior version of the machine-learned model to identify the modification to the first model layer of the plurality of model layers of the machine-learned model.

4. The method of claim 1, wherein the first modification tracking variable of the plurality of modification tracking variables tracks the number of modifications applied during the prior training iterations to the first model layer of the plurality of model layers, wherein a second modification tracking variable of the plurality of modification tracking variables tracks the number of modifications applied during the prior training iterations to the a second model layer of the plurality of model layers; and
wherein, prior to updating the first modification tracking variable, the second modification tracking variable was less than or equal to the first modification tracking variable.

5. The method of claim 4, wherein generating the second container image from the first container image that comprises the plurality of container image layers comprises:
responsive to updating the first modification tracking variable, making a determination that the first modification tracking variable is greater than the second modification tracking variable; and
based on the determination, determining the second sequence in which the set of container image layers are ordered in the second container image.

6. The method of claim 1, wherein identifying the modification to the first model layer of the plurality of model layers of the machine-learned model comprises:
determining that the first model layer comprises a new model layer added to the machine-learned model subsequent to creation of the prior version of the machine-learned model.

7. The method of claim 1, wherein the machine-learned model comprises a decision tree model comprising a plurality of nodes and a plurality of branches.

8. The method of claim 7, wherein the first model layer comprises a first node of the plurality of nodes, and wherein the modification to the first model layer comprises an adjustment to a decision value associated with the first node.

9. The method of claim 7, wherein, prior to identifying the modification to the first model layer of the plurality of model layers, the method comprises:
generating the first container image comprising the plurality of container image layers, wherein generating the first container image comprises:
storing the decision tree model as a file structure comprising a plurality of file paths, wherein each file path of the plurality of file paths represents a corresponding model layer of the plurality of model layers of the decision tree model; and
generating the first container image comprising the plurality of container image layers, wherein the first container image stores each file path of the plurality of file paths as a corresponding container image layer of the set of container image layers.

10. The method of claim 9, wherein generating the first container image comprising the plurality of container image layers comprises:
generating mapping information that maps the plurality of file paths to the set of container image layers, wherein a base file path of the plurality of file paths is mapped to a foundational image layer of the plurality of container image layers.

11. The method of claim 10, wherein the base file path of the plurality of file paths stores a root node of the plurality of nodes of the decision tree model.

12. The method of claim 9, wherein the plurality of nodes of the decision tree model comprises a second node connected to a first node by a first branch of the plurality of branches, wherein the plurality of file paths comprises a first file path that represents the first node and a second file path that represents the second node, and wherein the second file path depends from the first file path.

13. The method of claim 9, wherein generating the first container image comprising the plurality of container image layers comprises:
ordering the set of container image layers in a random sequence.

14. A computing system, comprising:
a memory; and
one or more processor devices coupled to the memory to:
identify a modification to a first model layer of a plurality of model layers of a machine-learned model based on a comparison between the machine-learned model and a prior version of the machine-learned model;
update a first modification tracking variable of a plurality of modification tracking variables, wherein each of the plurality of modification tracking variables tracks a number of modifications applied during prior training iterations to a corresponding model layer of the plurality of model layers;
access a first container image comprising a plurality of container image layers, wherein a set of container image layers of the plurality of container image layers stores the plurality of model layers of the machine-learned model, and wherein the set of container image layers is ordered in a first sequence within the first container image; and
based on the first modification tracking variable, generate a second container image from the first container image that comprises the plurality of container image layers, wherein the set of container image layers is ordered in a second sequence within the second container image, and wherein the second sequence is different than the first sequence.

15. The computing system of claim 14, wherein, to identify the modification to the first model layer of the plurality of model layers of the machine-learned model based on the comparison between the machine-learned model and the prior version of the machine-learned model, the one or more processor devices are to:
load the machine-learned model from the first container image;
load the prior version of the machine-learned model from a container image that stores the prior version of the machine-learned model; and
compare the machine-learned model and the prior version of the machine-learned model to identify the modification to the first model layer of the plurality of model layers of the machine-learned model.

16. The computing system of claim 14, wherein, to identify the modification to the first model layer of the plurality of model layers of the machine-learned model based on the comparison between the machine-learned model and the prior version of the machine-learned model, the one or more processor devices are to:
compare information indicative of the first container image and information indicative of a container image that stores the prior version of the machine-learned model to identify the modification to the first model layer of the plurality of model layers of the machine-learned model.

17. The computing system of claim 14, wherein the first modification tracking variable of the plurality of modification tracking variables tracks the number of modifications applied during the prior training iterations to the first model layer of the plurality of model layers, wherein a second modification tracking variable of the plurality of modification tracking variables tracks the number of modifications applied during the prior training iterations to a second model layer of the plurality of model layers; and
wherein, prior to updating the first modification tracking variable, the second modification tracking variable was less than or equal to the first modification tracking variable.

18. The computing system of claim 17, wherein, to generate the second container image from the first container image that comprises the plurality of container image layers, the one or more processor devices are to:
responsive to updating the first modification tracking variable, make a determination that the first modification tracking variable is greater than the second modification tracking variable; and
based on the determination, determine the second sequence in which the set of container image layers are ordered in the second container image.

19. The computing system of claim 14, wherein, to identify the modification to the first model layer of the plurality of model layers of the machine-learned model, the one or more processor devices are to:
determine that the first model layer comprises a new model layer added to the machine-learned model subsequent to creation of the prior version of the machine-learned model.

20. A non-transitory computer-readable storage medium that includes executable instructions to cause one or more processor devices to:
identify a modification to a first model layer of a plurality of model layers of a machine-learned model based on a comparison between the machine-learned model and a prior version of the machine-learned model;
update a first modification tracking variable of a plurality of modification tracking variables, wherein each of the plurality of modification tracking variables tracks a number of modifications applied during prior training iterations to a corresponding model layer of the plurality of model layers;
access a first container image comprising a plurality of container image layers, wherein a set of container image layers of the plurality of container image layers stores the plurality of model layers of the machine-learned model, and wherein the set of container image layers is ordered in a first sequence within the first container image; and
based on the first modification tracking variable, generate a second container image from the first container image that comprises the plurality of container image layers, wherein the set of container image layers is ordered in a second sequence within the second container image, and wherein the second sequence is different than the first sequence.
